(19) United States
(12) Patent Application Publication
(10) Pub. No.: US 2023/0336003 A1
(43) Pub. Date: Oct. 19, 2023

(54) Battery Charging Management System and Battery Charging Management Method

(71) Applicant: Andreas Stihl AG & Co. KG, Waiblingen (DE)

(72) Inventors: Raphael WEGMANN, Leonberg (DE); Friedhelm KOCH, Allmersbach im Tal (DE); Michael GRZYBEK, Waiblingen (DE); Christian SAEMANN, Stuttgart (DE); Christian SPINDLER, Stuttgart (DE)

(21) Appl. No.: 18/133,763

(22) Filed: Apr. 12, 2023

(30) Foreign Application Priority Data
Apr. 13, 2022 (EP) 22168193.5

(51) Int. Cl. H02J 7/00; B60L 53/62; B60L 53/65; B60L 53/66

(52) U.S. Cl. CPC H02J 7/00036; H02J 7/0013; H02J 7/0063; H02J 7/007; H02J 7/0047; B60L 53/62; B60L 53/65; B60L 53/66

(57) ABSTRACT

A battery charging management system and method for a battery fleet having a plurality of rechargeable, communication-enabled, battery units, includes a charging management base configured for transmitting charging setting information for the battery units, a plurality of user terminals configured for transmitting battery-charging-related user predefinition information, a respective charging control unit in each of the battery units, and a communication connection for data transfer between the charging management base at one end and the battery units at the other end and between the user terminals at one end and the charging management base and/or the battery units at the other end. The charging setting information and/or the user predefinition information includes charging mode information with regard to a plurality of different charging modes for the battery units. The charging setting information and/or the user predefinition information are able to be fed to the charging control unit in the respective battery unit via the communication connection. The respective charging control unit is configured, for the purpose of performing a charging process of its battery unit coupled to a charger, to define associated charging parameter desired value information depending on the charging setting information and/or user predefinition information fed and to communicate it to the charger.

### CROSS REFERENCE TO RELATED APPLICATION

This application claims priority under 35 U.S.C. § 119 from European Patent Application No. 22168193.5, filed Apr. 13, 2022, the entire disclosure of which is herein expressly incorporated by reference.

### BACKGROUND AND SUMMARY

The invention relates to a battery charging management system for a battery fleet having a plurality of rechargeable, communication-enabled battery units, and to a corresponding battery charging management method, wherein the battery charging management system comprises a charging management base configured for transmitting charging setting information for the battery units.

Systems and methods of this kind are used for charging management for the electrically rechargeable battery units, which comprises in particular corresponding measures for setting, controlling and performing electrical charging processes for the battery units. The battery units are combined to form the battery fleet, i.e. to form a totality from which one or more users can make use in order to obtain a respective battery unit for an intended purpose of use. The battery units can be of identical or different designs or of identical or different types and can be realized for example as so-called rechargeable battery packs such as are usually used for supplying energy to diverse electrically driven apparatuses. Said apparatuses can be e.g. hand-guided work apparatuses, such as handheld or ground-supported work apparatuses or working apparatuses in the construction and do-it-yourself fields, in gardening and in forestry.

Diverse battery charging management systems of this and similar kinds and battery charging management methods that can be performed by them are already common, wherein the charging management measures may depend on the type, kind and demand for use of the battery units and further parameters that influence the state of charge and the performance of the charging processes. One such influencing parameter that is often taken into account is the battery temperature, see e.g. patent publication EP 2 879 227 B1.

Battery charging management systems of the kind considered in the present case have enough system intelligence, in particular battery charging intelligence, in the sense of corresponding computer intelligence, to ascertain and to initiate or to control the desired charging measures. In the case of conventional systems, this system intelligence is normally implemented completely or predominantly in the charging management base, e.g. in a charging management base embodied as a server computer, or server for short, and/or in one or more charging stations or chargers of the system.

Laid-open application EP 3 506 456 A1 discloses a battery charging management system of the kind mentioned at the outset, wherein the charging management base comprises a server, which receives charging demand requirements and battery-specific battery state information, such as regarding type, date of manufacture, capacity, state of health, state of charge and battery temperature, from a battery exchange station, in which the battery units of the battery fleet, each having a battery management system, can be positioned. The server creates therefrom battery-specific or type- or group-specific charging plans and communicates corresponding charging commands to the battery exchange station. In that case, the server is also said to have the capability of ascertaining customized battery charging profiles virtually in real time, and instructing the battery exchange station to perform the charging process accordingly. The battery charging management method that can be carried out by this system includes, inter alia, the possibility of a just-in-time setting of the charging profile, which prioritizes slower charging for periods in which a demand for use of the battery unit is not expected or the charging costs are lower, and switches to faster charging as soon as a predicted demand is identified in order to fully charge the battery unit prior to use.

Patent publication EP 2 457 302 B1 discloses the measure, for performing the charging process for a battery e.g. in a smartphone, of selecting from various predefined charging profiles the charging profile that is currently to be used, depending on start time and/or end time and/or the charging duration, wherein in particular a charging profile for charging the battery with lower power is prioritized for charging periods in which an active use of the apparatus fed by the battery is not expected, in order to lengthen the lifetime of the battery, and a charging profile for charging the battery with higher power is chosen for charging periods in which the apparatus is expected to be used soon, in order to shorten the charging duration.

Patent publication EP 3 413 424 B1 discloses the measure of ascertaining the energy demand of a battery unit for an imminent work deployment and of creating a charging duration prediction for the battery units of the battery fleet and of thus finding the battery unit with the shortest predicted charging duration.

Laid-open application EP 2 418 749 A1 discloses a charging management which is intended e.g. for battery units in the smart home field and includes the measure of prioritizing charging processes for which renewably generated electrical energy is available in order to keep down CO₂ emissions.

The invention addresses the technical problem of providing a battery charging management system and a battery charging management method of the kind mentioned in the outset which offer more extensive improvements of battery charging management by comparison with the prior art mentioned above.

The invention solves this problem by providing a battery charging management system and a battery charging management method having the features of the independent claims. Advantageous developments of the invention are specified in the dependent claims, the wording of which is hereby incorporated by reference as part of the description. This in particular also includes all embodiments of the invention which arise from the combinations of features defined by the dependency references in the dependent claims.

The battery charging management system according to the invention comprises a charging management base configured for transmitting charging setting information for the battery units, a plurality of user terminals configured for transmitting battery-charging-related user predefinition information, a respective charging control unit in each of the battery units, and a communication connection for data transfer between the charging management base at one end and the battery units at the other end and between the user terminals at one end and the charging management base and/or the battery units at the other end. It goes without saying that the charging management base and/or the user terminals can have further implemented functionalities depending on demand and application, preferably including functionalities such as are mentioned elsewhere in the present case or are known per se to a person skilled in the art from conventional components of this kind.

The charging setting information and/or the user predefinition information comprise(s) charging mode information with regard to a plurality of different charging modes for the battery units. The charging setting information from the charging management base and/or the user predefinition information from the user terminals are/is able to be fed to the charging control unit in the respective battery unit via the communication connection. Depending on the system realization, the charging setting information and/or the user predefinition information consist(s) solely of the charging mode information or contain(s) additional battery-charging-related information. In any case the respective charging control unit thereby acquires knowledge of a desired or required charging mode, optionally supplemented by further charging-relevant information. The charging setting information is preferably kept available in the charging management base by virtue of it being suitably stored there. The user predefinition information can be kept available, i.e. stored, in the respective user terminal and can be selected by the user for transmission to the charging management base and/or the respective charging control unit, and/or it can be input by the user for transmission to the charging management base and/or the respective charging control unit at the user terminal.

The respective charging control unit is configured, for the purpose of performing a charging process of its battery unit coupled to a charger, to define associated charging parameter desired value information depending on the charging setting information and/or user predefinition information fed and thus in particular depending on the charging mode information contained therein and to communicate it to the charger. The system intelligence required for the system can therefore be implemented for the most part in the charging control units and thus in the battery units. Both the charger(s) and the charging management base can thus be relieved of the burden of corresponding system intelligence implementations and can be optimized towards, or focused on, fulfilling other functions, such as the communication functions required for the charging management of the fleet.

The battery charging management system according to the invention designed in this way makes it possible, in a simple and optimum manner, to ascertain and perform charging processes for the battery units of the fleet. As necessary, the user can use his/her user terminal to predefine a desired charging mode and optionally further charging predefinitions for a selected or any desired one of the battery units, e.g. including information about an intended time of use and/or an intended purpose of use, as user predefinition information and can communicate same to the charging management base and/or the respective charging control unit. The respective charging control unit in the relevant battery unit is able, by virtue of the charging intelligence implemented in it, to ascertain whether the charging mode that the user desires is optimal at present when other conditions are taken into account as well, or alternatively a different charging mode should be given preference, e.g. taking account of an anticipated charging duration ascertained and/or a detected state of charge and/or state of health of the battery unit and/or a notified time of use and/or purpose of use of the battery unit and/or an ascertained or detected battery temperature and/or taking account of sustainability aspects and/or charging current cost aspects. As necessary, the charging control units can also initiate charging processes for their battery units automatically, i.e. without a present user requirement, in order to keep the entire battery fleet optimally ready for use. In any case the respective charging control unit then instructs the charger providing the charging current or the charging voltage to perform the charging process ascertained as optimal, by communicating the corresponding charging parameter desired value information to the charger.

The definition of the charging parameter desired values by the charging control unit in each battery unit and the communication to the charger make it possible to supervise the charging process of each battery unit independently of the charger respectively used. This can also make it possible to use different types of charger to which the battery units can be electrically connected. As necessary, provision can also be made for a respective battery unit to be charged by a plurality of sequential charging processes with identical or different charging parameters using the same or different chargers. The communication connection makes it possible to transfer the charging setting information, including the charging mode information, and the user predefinition information and, as necessary, all kinds of battery state data relevant to charging processes, such that the relevant information or data, in a respectively desired manner, can be stored at a desired storage location and/or can be evaluated or processed further by an evaluation unit provided for this purpose e.g. in the respective charging control unit or the respective user terminal or the charging management base.

The communication connection is preferably a conventional wireless communication connection and can be in particular a Bluetooth, LTE, WiFi, Zigbee, GSM, LAN or similar connection. It can provide the communicative connection between respective battery unit, charging management base and respective user terminal directly without the interposition of other communication components or indirectly, i.e. with the interposition of one or more other communication components, such as a gateway or the like. In this case, the communication connection can be embodied integrally or in a multipartite fashion, in particular consisting of a plurality of different communication channels. In the latter case, it can include for example one or more Bluetooth channels and one or more Internet connection channels such as LTE or WiFi channels, including possible corresponding transfer units such as gateways that mediate between the different channels. The data transfer can take place in any desired conventional manner, e.g. sequentially or as data packets and/or cyclically. Data can be transferred simultaneously or successively to one or a plurality of the battery units.

The charging management base can include e.g. a server, a database, a cloud base or the like.

The respective user terminal can include e.g. a computer or a mobile device such as a smartphone, a tablet, a smartwatch or the like.

In a development of the invention, the battery units are embodied as rechargeable battery packs for supplying energy to hand-guided work apparatuses, in particular hand-guided garden, forestry, construction and/or groundwork apparatuses. This can be e.g. a lawnmower, a pole-mounted pruner, a hedge trimmer, a motor saw, an angle grinder, etc. Alternatively, the battery units can serve for supplying energy to other apparatuses or machines, e.g. for autonomous groundwork apparatuses, such as mowing robots, or electric vehicles, such as e-bikes.

In a development of the invention, identifier information is allocatable to each battery unit, and the user terminals and/or the charging management base are/is configured for grouping the battery units into one or more identical charging groups using the identifier information. Here in the present case an identical charging group should be understood to mean a group comprising one or a plurality of the battery units which, in relation to the battery charging management system, among themselves are usable in an identical way or interchangeably for a specific purpose of use and/or for supplying energy to an assigned apparatus or machine team or pool of apparatuses or machines and are chargeable for this purpose. This makes available an advantageous divisibility of the battery fleet into groups of battery units, each of which can be assigned e.g. to a specific use team, such as a forest team for forest work and/or a mowing team for mowing work, etc. In this case, it is also possible to assign a corresponding battery unit to a plurality of different use teams. Alternatively, such a group divisibility of the battery fleet can be dispensed with.

In a development of the invention, the charging modes comprise a plurality out of a non-charging mode, a normal charging mode, a rapid charging mode, a gentle charging mode and a sustainable charging mode, and the charging management base and/or the user terminals and/or the charging control units is/are configured to define the charging mode information and/or the charging parameter desired value information depending on prioritization information and/or use history information.

In the present case, non-charging mode is understood to mean that the battery unit is not charged in the associated period. The normal charging mode constitutes a reference to which the other charging modes refer for comparison. The gentle charging mode enables the battery unit to be charged very gently in comparison with the normal charging mode over a longer available period, which is beneficial for a long lifetime of the battery unit. The rapid charging mode makes it possible to ensure that the battery unit can be fully charged or at least brought to a required state of charge in a relatively short time if it is intended to be used soon. The sustainable charging mode enables the battery units to be charged in an optimized manner in regard to sustainability aspects.

The prioritization information can take account of e.g. battery lifetime, use time, charging cost and/or sustainability aspects. The use history information can take account of e.g. typical use periods or non-use periods of the battery units such as can be ascertained by the system on the basis of corresponding data about the use of the battery unit in the past. This development therefore advantageously contributes to finding or defining the best possible charging process for the respective situation. Alternatively, e.g. algorithms without prioritization and use history information can be used for defining the respectively prevailing charging process if this is sufficient for the relevant application.

In a refinement of the invention, the use history information comprises information about a non-use period and the prioritization information comprises a prioritization of the gentle charging mode for the non-use period. As a result, the system is advantageously able to automatically preset gentle charging of the battery unit in corresponding periods, which lengthens the lifetime of the battery unit. Alternatively, the prioritization of the gentle charging mode can be omitted or made dependent on other conditions.

In a refinement of the invention, the use history information comprises information about an expected use start time and the prioritization information comprises a prioritization of the rapid charging mode depending on the expected use start time. As a result, the system is advantageously able to automatically preset rapid charging of the battery unit in order that the latter is sufficiently charged at the expected time of its use. Alternatively, a prioritization of the rapid charging mode can be omitted or made dependent on other conditions. In a corresponding realization, the prioritization information can generally include a prioritization of a charging mode ascertained as best matching depending on the expected use start time and the present state of the battery unit, in order on the one hand to charge the battery unit as gently as possible and on the other hand to have enough battery capacity available for the imminent use process at the use time.

In a refinement of the invention, the user predefinition information comprises information about a required use start time and the user terminals and/or the charging management base and/or the charging control units is/are configured to define the charging mode information and/or the charging parameter desired value information depending on the required use start time. This measure advantageously enables optimum target time charging, wherein the system, preferably the respective charging control unit, with knowledge of the use time and the state of its battery unit, can define and initiate an optimum charging process for the battery unit, such that firstly the latter has reached the required state of charge at the desired time and secondly the charging takes place with the charging-relevant parameters being taken into account in an optimizing manner. Alternatively, in simplified embodiments, the system can manage without this use-time-dependent charging process optimization.

In a development of the invention, the respective charging control unit is configured for detecting at least one charging-relevant battery state parameter of its battery unit and for defining the charging parameter desired value information for the relevant battery unit depending on the detected values of the at least one battery state parameter. This advantageously enables the optimization of the respective charging process taking account of the state of the relevant battery unit, e.g. the type thereof, the temperature thereof and/or the state of health thereof. As necessary, the detected battery state data can be stored and/or evaluated in some other way and/or can be output or displayed by the charging control unit and/or can be transferred to the user terminals and/or to the charging management base. Alternatively, in a simplified embodiment, the system can define the charging parameter desired value information without taking account of detected battery state parameters if this is sufficient for the relevant application.

In a development of the invention, the charging parameter desired value information comprises different charging current and/or charging voltage desired value predefinitions for at least five different battery temperature ranges, wherein the charging parameter desired value information predefines the non-charging mode below a minimum temperature and above a maximum temperature, predefines a progressively higher charging current and/or a progressively higher charging voltage for a sequence of at least two battery temperature ranges adjacent to the minimum temperature, and predefines a constant or progressively lower charging current and/or a constant or progressively lower charging voltage for a sequence of at least two battery temperature ranges adjacent to the maximum temperature. This temperature-dependently variable definition of the charging process can advantageously contribute to a lengthening of the lifetime of the battery unit, and the battery temperature can be prevented from rising excessively, without said battery temperature needing to be compulsorily constantly monitored for this purpose. Alternatively, such a temperature-dependent prior definition of charging current and/or charging voltage desired value predefinitions can be dispensed with and a real-time reaction to constantly ascertained battery temperature information can be implemented, or the predefinition includes only four or fewer different battery temperature ranges.

In a development of the invention, the charging setting information and/or the user predefinition information include(s) at least one out of target battery capacity information, target battery energy information, target battery voltage information and target battery use duration information. With knowledge of the target battery capacity information, the charging control unit is able to charge the relevant battery unit in a targeted manner up to a battery capacity thereby predefined as a target, e.g. to an optimum storage capacity value for the storage of the battery unit, which can be e.g. in the range of between 75% and 85% of the full battery capacity. Knowledge of the target battery energy information can enable the charging control unit to charge the relevant battery unit in a targeted manner until it has stored a desired amount of energy which is predefined as a target and which is expected to be required e.g. for an imminent work deployment. The predefinition of a specific target battery voltage can be useful for the charging control unit in order to charge the relevant battery unit in a targeted manner up to the battery voltage thereby desired. Knowledge of the target battery use duration information enables the charging control unit to charge the battery unit in a targeted manner to an extent such that the latter is able to provide the energy required for a work deployment for the use duration thereby predefined. In alternative embodiments, these predefinitions can be dispensed with; by way of example, it may possibly be sufficient for the charging setting information and/or the user predefinition information to contain only the charging mode information.

In the case of the battery charging management method according to the invention, charging setting information for the battery units is kept available in a charging management base, the battery units are equipped with a respective charging control unit, a plurality of user terminals are provided, at which battery-charging-related user predefinition information is able to be input, and provision is made of a wireless communication connection for data transfer between the charging management base at one end and the battery units at the other end and between the user terminals at one end and the charging management base and/or the battery units at the other end. The charging setting information and/or the user predefinition information comprise(s) charging mode information with regard to a plurality of different charging modes for the battery units. The charging mode information is fed from the charging management base and/or from the respective user terminal to the charging control unit in the respective battery unit via the communication connection. For the purpose of performing a charging process for the respective battery unit coupled to a charger, by way of the charging control unit of said battery unit, associated charging parameter desired value information is defined depending on the charging mode information fed and is communicated to the charger. Consequently, the properties and advantages that arise for this battery charging management method are analogously the same as those mentioned above in respect of the battery charging management system according to the invention, to which reference may be made in order to avoid repetitions.

In a development of the invention, the battery charging management method is carried out by the battery charging management system according to the invention, which constitutes an implementation of the method that is advantageous by comparison with other implementations.

In a development of the invention, for performing a respective charging process of one of the battery units by means of the associated charging control unit, the charging parameter desired value information is defined and periodically updated depending on detected actual values of the at least one charging-relevant battery state parameter of the battery unit. As a result, the temporal profile of the charging process can be optimally adapted to possibly changing conditions with regard to the state of the battery unit, such as to the instantaneous battery temperature, for example. This adaptation of the charging process to the instantaneous battery state can in particular also include a changeover between the different possible charging modes during the charging process. Alternatively, provision can be made for performing the charging process without adaptively taking account of the battery state, if this is sufficient for the relevant application.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram illustration of a battery charging management system;

FIG. 2 is a schematic block diagram illustration of a more concrete realization of the battery charging management system from FIG. 1;

FIG. 3 is a characteristic curve diagram for elucidating various battery-temperature-dependent charging current predefinitions for two different charging modes; and

FIG. 4 is a flow diagram illustration of a charging mode selection procedure of a battery charging management method.

### DETAILED DESCRIPTION OF THE DRAWINGS

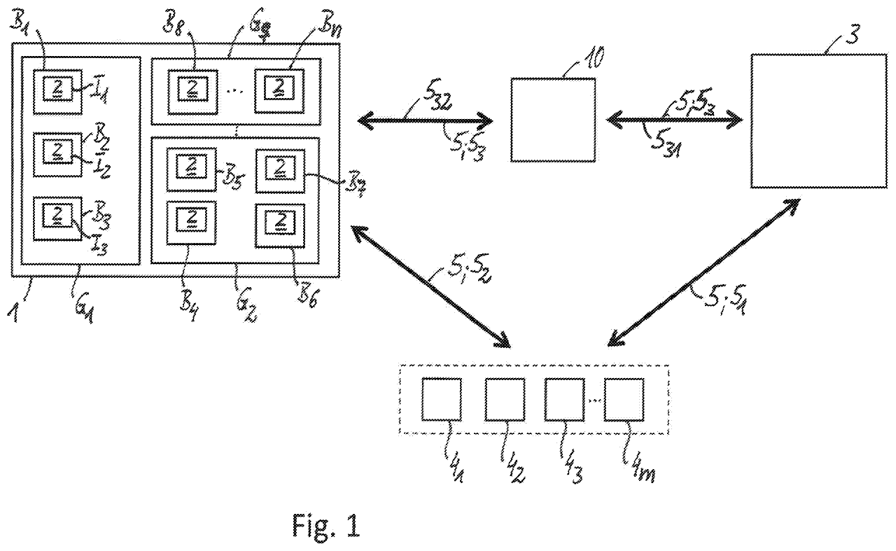

FIG. 1 schematically shows a battery charging management system for a battery fleet 1 comprising a number n of rechargeable, communication-enabled battery units B₁, . . . , Bₙ, where n is an arbitrary natural number greater than one. Each battery unit B₁, . . . , Bₙ has a dedicated charging control unit 2. Furthermore, the battery charging management system comprises a charging management base 3 configured for transmitting charging setting information for the battery units B₁, . . . , Bₙ, a number m of user terminals 4₁, . . . , 4ₘ, where m is an arbitrary natural number greater than one, and a communication connection 5 for data transfer between the charging management base 3 at one end and the battery units B₁, . . . , Bₙ at the other end and between the user terminals 4₁, . . . , 4ₘ at one end and the charging management base 3 and/or the battery units B₁, . . . , Bₙ at the other end. The user terminals 4₁, . . . , 4ₘ are configured for transmitting battery-charging-related user predefinition information.

Preferably, as in the example shown, the communication connection 5 is embodied in wireless fashion and, depending on the application, includes one or more communication channels and suitable communication components or communication interfaces in the user terminals 4₁, . . . , 4ₘ, the charging control units 2 and the charging management base 3 and optionally externally, i.e. outside these system components mentioned. By way of example, in this regard, in the exemplary embodiment in FIG. 1, provision is made of a first communication channel Si between the user terminals 4₁, . . . , 4ₘ at one end and the charging management base 3 at the other end, a second communication channel 5₂ between the user terminals 4₁, . . . , 4ₘ at one end and the battery fleet 1 or the battery units B₁, . . . , Bₙ at the other end and a third communication channel 5₃ between the charging management base 3 at one end and the battery fleet 1 or the battery units B₁, . . . , Bₙ at the other end, wherein the third communication channel 5₃ is routed via an intermediate station 10 in the form of a gateway unit, for example, and is thereby subdivided into two sequential sub-channels 5₃₁, 5₃₂ between the charging management base 3 and the intermediate station 10 and, respectively, between the intermediate station 10 and the battery fleet 1. Preferably, the sub-channel 5₃₂ and the second communication channel 5₂ are each realized by a short-range communication connection, in particular a Bluetooth connection, while the sub-channel 5₃₁ and the first communication channel 5₁ are preferably each realized by a long-range communication connection, in particular an Internet connection such as an LTE, WiFi, GSM, or LAN connection.

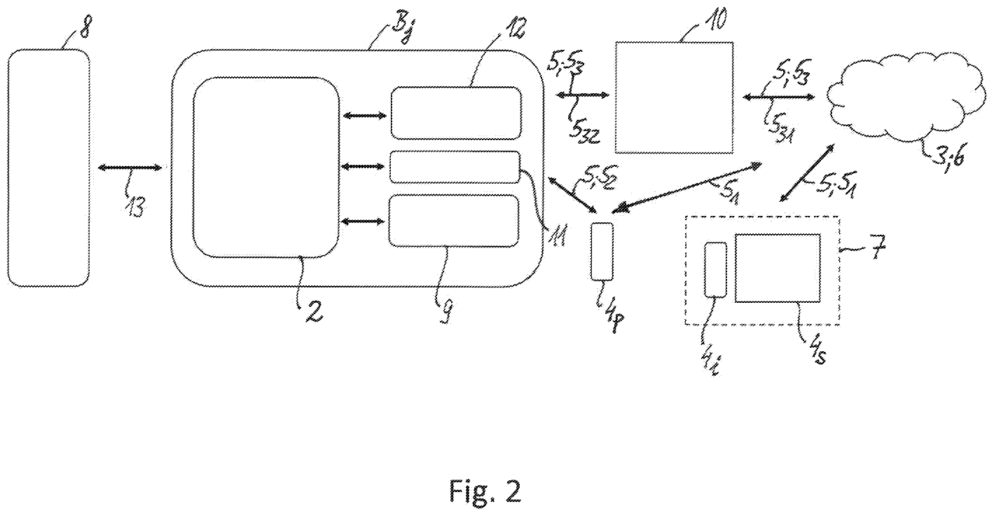

FIG. 2 shows an advantageous realization of the system from FIG. 1, wherein reference is made by way of example to a j-th battery unit Bⱼ. In this realization, the charging management base 3 is formed by a cloud backend 6 of a conventional kind per se, the user terminals 4₁, . . . , 4ₘ are part of a user frontend 7 of a conventional kind per se, wherein an i-th user terminal 4ᵢ in the form of a smartphone is shown in a representative manner, and the frontend 7 can comprise further user terminals, e.g. a tablet 4s, a personal computer, i.e. PC, or the like. The frontend 7 can be situated spatially far away from the battery fleet 1, wherein at the location of the battery fleet 1 the user can communicate directly with the respective battery unit Bⱼ or with the backend 6 or the intermediate station 10 e.g. by way of a smartphone that the user carries, represented by a user terminal 4ₚ in FIG. 2. The charging control unit is realized e.g. by a microcontroller with implemented battery management functions.

The charging setting information and/or the user predefinition information comprise(s) charging mode information with regard to a plurality of different charging modes and can be fed to the charging control unit 2 in the respective battery unit B₁, . . . , Bₙ via the communication connection 5. The charging control unit 2 is configured, for the purpose of performing a charging process of its battery unit B₁, . . . , Bₙ coupled to a charger, such as a charger 8 shown schematically in FIG. 2, to define associated charging parameter desired value information depending on the charging setting information and/or user predefinition information fed and to communicate it to the charger 8. For this purpose, in a corresponding realization, the charging parameter desired value information can be stored depending on the charging mode information, i.e. charging mode predefinitions, in the charging control unit 2.

The charging parameter desired value information can relate in particular to the fact that the charger 8 carries out a charging process for the respective battery unit B₁, . . . , Bₙ according to a charging mode such as is determined by the charging mode information contained in the charging setting information and/or user predefinition information fed. The respective battery unit B₁, Bₙ, or more precisely the charging control unit 2 thereof, communicates the charging parameter desired value information, i.e. the information about desired values of the charging parameters determining the charging process, to the charger 8 in a conventional manner via an associated communication connection 13 in wired fashion, e.g. via charging terminals of the battery unit B₁, . . . , Bₙ, or wirelessly. The charger 8 can be of any conventional type. The communication connection 13 can as necessary also be used to communicate data from the charger 8 to the battery unit B₁, . . . , Bₙ or the charging control unit 2.

As necessary and depending on the application, the user predefinition information can in particular also contain information that is useful for various aspects of target time charging, wherein the user can effect predefinitions for the charging control unit 2 regarding at what time the user would like to have available which battery unit of the battery fleet 1 with what state of charge. Such target predefinitions can include e.g. information about a desired battery unit or a desired battery type, a desired use time, a desired purpose of use, i.e. in what work apparatus the battery unit is intended to be used, a desired battery voltage and/or a desired amount of energy. The charging setting information, too, can contain further predefinition information in addition to pure charging mode information, such as the predefinition of an optimum state of charge for relatively long storage of the respective battery unit B₁, . . . , Bₙ, for which a state of charge amounting to approximately 80% of the state of full charge is often chosen, and/or the predefinition of a prioritized charging mode, such as the gentle charging mode that is optimal for the lifetime of the battery unit, or the sustainable charging mode that is optimal in regard to environmental aspects. The charging control unit 2 then ascertains the optimum charging process in each case for the relevant battery unit B₁, . . . , Bₙ taking account of these target predefinitions. In this regard, the charging control unit 2 can for example be configured, inter alia, for ascertaining on the basis of the information about the desired use time and the desired work apparatus, said information being fed in by the user, how much charging the relevant battery unit B₁, . . . , Bₙ requires and with what charging mode or what charging parameter desired value information this charging can be effected in the best possible way.

In corresponding realizations, each of the charging control units 2 of the battery units B₁, . . . , Bₙ has software, more specifically firmware, which, in particular with regard to its versions, need not be identical in all battery units B₁, Bₙ, i.e. different battery units B₁, . . . , Bₙ can have different firmware. The firmware can be transferred, in particular updated, e.g. via the communication connection 5 from one of the user terminals 4₁, . . . , 4ₘ and/or from the charging management base 3 to the charging control unit 2. In advantageous embodiments, the charging control unit 2 can implement or define the assignment of charging parameter desired values depending on the charging mode information fed in accordance with the firmware, i.e. communication of a different firmware, in particular firmware version, from the charging management base 3 and/or the user terminal 4₁, . . . , 4ₘ can be used to influence, in particular determine or program or define, how the charging control unit 2 defines charging parameter desired values depending on the charging mode information fed.

In the advantageous embodiment shown in FIG. 2, the respective battery unit Bⱼ includes a sensor system 12 for detecting charging parameters in addition to the charging control unit 2. The sensor system 12 can comprise in particular sensors for detecting internal battery temperature and/or ambient temperature, voltage and/or current. In this regard, voltage and/or current can be measured e.g. by means of cables connected to individual series blocks in the battery unit B or the rechargeable battery pack, in particular by way of so-called balancer cables. A temperature sensor can be arranged in the battery unit Bⱼ in particular between or under battery cells arranged therein and/or at the edge or on the inner side of a housing of the battery unit Bⱼ. In this way, in particular the temperature of the battery unit Bⱼ and the electrical voltage providable at present by the battery unit Bⱼ or the state of charge thereof can be detected by means of the sensor system 12, whereby specifically actual values of relevant, monitored charging parameters can also be detected and monitored.

Furthermore, in this embodiment shown, the battery unit Bⱼ includes a communication interface 9 for linking to the communication connection 5 in order to communicate data such as e.g. detected charging parameter data and/or battery state information to the user terminals 4₁, . . . , 4ₘ and/or to the intermediate station 10 and/or to the charging management base 3 and to receive the charging setting information and/or the user predefinition information.

Furthermore, in this embodiment shown, the battery unit Bⱼ has an e.g. optical display unit 11, for example having one or more light-emitting diodes, i.e. LEDs. On the display unit 11, the battery unit Bⱼ and/or the charging control unit 2 can display or output, as necessary, actual values of charging parameters such as e.g. a present state of charge and/or charging current and/or a present charging power and/or battery temperature at the battery unit Bⱼ.

In corresponding embodiments, the respective battery unit B₁, . . . , Bₙ is designed as a rechargeable battery pack for supplying energy to hand-guided work apparatuses, in particular hand-guided garden, forestry, construction and/or groundwork apparatuses, or autonomous groundwork apparatuses, such as mowing robots, or electrically driven vehicles, such as e-bikes. A person skilled in the art knows many different types of such rechargeable battery packs, and so there is therefore no need here for further explanations in respect of this. In this regard, the respective rechargeable battery pack can comprise in particular a plurality of rechargeable battery cells which are arranged in the battery unit B₁, . . . , Bₙ in a manner electrically interconnected in series and/or in parallel. The respective rechargeable battery cell can be designed e.g. as a cylindrical cell, in particular as a so-called 18650 cell or 21700 cell, or as a pouch cell. The rechargeable battery cell is preferably a lithium-ion cell, but other materials, such as nickel-metal hydride or nickel-cadmium, are also possible. The battery units B₁, . . . , Bₙ can have different sizes or dimensions, in particular length, width, height or mass. Furthermore, they can differ from one another in terms of their maximum energy contents.

In advantageous embodiments, as illustrated schematically for the example shown in FIG. 1, identifier information I₁, . . . , Iₙ is allocatable to each battery unit B₁, . . . , Bₙ. By way of this identifier information I₁, . . . , Iₙ, the respective battery unit B₁, . . . , Bₙ is uniquely identifiable and distinguishable from all other battery units. The identifier information I₁, . . . , Iₙ can be of any conventional kind as known per se to a person skilled in the art, e.g. in the form of corresponding digital ID (identification) codes.

As likewise shown in FIG. 1, the user terminals 4₁, . . . , 4ₘ and/or the charging management base 3 are/is configured in this case, using the identifier information I₁, . . . , In, to group one or more of the battery units B₁, . . . , Bₙ into a number q of identical charging groups G₁, . . . , G_{q}, where q is an arbitrarily predefinable natural number. Specifically, in the case shown, by way of example, the battery units B₁, B₂ and B₃ are assigned to an identical charging group G₁, the battery units B₄, B₅, B₆ and B₇ are assigned to an identical charging group G₂ and the battery units B₈ to Bₙ are assigned to an identical charging group G_{q}. However, the assignment can also be effected differently, in particular have more or fewer battery units B₁, . . . , Bₙ and/or identical charging groups G₁, . . . , G_{q}. Generally, the battery units B₁, . . . , Bₙ of the battery fleet 1 may in this case not be grouped at all or may be divided into just a single or a plurality of identical charging groups G₁, . . . , G_{q}. None, one, a plurality or all of the battery units B₁, . . . , Bₙ can be allocated to an identical charging group G₁, . . . , G_{q}. Furthermore, provision can be made for a respective battery unit B₁, . . . , Bₙ to be assigned to none or just a single or a plurality of the identical charging groups G₁, . . . , G_{q} at a respective time. If a battery unit B₁, . . . , Bₙ that is already assigned to a first identical charging group G₁, . . . , G_{q} is assigned to a second identical charging group G₁, . . . , G_{q}, it can additionally remain assigned to the first identical charging group G₁, . . . , G_{q} or instead be removed from the first identical charging group G₁, . . . , G_{q}, in particular in a manner selectable by the user.

In corresponding realizations, a respective identical charging group G₁, . . . , G_{q} can be created by a user, without a battery unit B₁, . . . , Bₙ already having been or being assigned to this identical charging group G₁, . . . , G_{q} at the time of creation. The assignment of a battery unit B₁, . . . , Bₙ may also take place only at an arbitrary time after the creation of an identical charging group G₁, . . . , G_{q}. This makes it possible that the identical charging groups G₁, . . . , G_{q} can be created and charging setting information and/or user predefinition information can be allocated to them, without battery units B₁, . . . , Bₙ having to be assigned directly thereto. As a result, the allocation of charging setting information and/or user predefinition information to individual battery units B₁, . . . , Bₙ and/or identical charging group G₁, . . . , G_{q} can take place more rapidly as necessary. It is also possible for the battery units B₁, . . . , Bₙ to be assigned to identical charging groups G₁, . . . , G_{q} automatically rather than by a user, in particular without user action, by means of a respective user terminal 4₁, . . . , 4ₘ and/or the charging management base 3. The automatic assignment can be effected e.g. after evaluation and/or depending on use hi story information.

An identical charging group can comprise e.g. battery units of identical or different types which can or are intended to be used for an identical specific purpose of use or an identical specific use team, e.g. a mowing team for lawnmowing work, a gardening team for work in agriculture/landscape design or a forestry team for forestry work.

In advantageous embodiments, the charging modes comprise a plurality out of a non-charging mode, a normal charging mode, a rapid charging mode, a gentle charging mode and a sustainable charging mode, with the properties of these different charging modes as already explained above in respect thereof. The charging management base 3 and/or the user terminals 4₁, . . . , 4ₘ and/or the charging control units 2 are configured to define the charging mode information depending on prioritization information and/or use history information. Additionally or alternatively, other or further charging modes can be encompassed. By way of example, it is possible for further charging modes to be defined by a user.

Use history information is gathered and/or stored information about the use of the battery units B₁, . . . , Bₙ in the past. Here, the use history information can be evaluated by the user terminals 4₁, . . . , 4ₘ and/or the charging management base 3. Use history information can comprise in particular information about use start times, use end times, use durations, delivered amounts of energy or powers and/or temperatures that occur in the process, in particular in the interior of the battery units B₁, . . . , Bₙ or in the vicinity thereof. Alternatively or additionally, the use history information can also comprise charging information, in particular battery charging parameters and/or battery state parameters, such as charging power, charging current, charging voltage and end-of-charge voltage, internal battery temperature and/or ambient temperature, charging duration, charging start time and/or charging end time.

If a plurality of items of charging mode information have been communicated to a battery unit B₁, Bₙ, the charging control unit 2 and/or the charging management base 3 and/or the user terminal 4₁, . . . , 4ₘ, using the prioritization information, define(s) charging parameter desired values which are dependent on one or more charging modes or are combined therefrom or are given by a single prioritized charging mode or by a charging mode selected as an optimum charging mode at present from a plurality of allocated charging modes.

The prioritization information makes it possible that charging mode information can be predefined by the system automatically without assistance or action on the part of the user and/or taking into account or even exclusively by means of an input or selection on the part of the user by way of a respective user terminal 4₁, . . . , 4ₘ.

In a corresponding embodiment, the use history information comprises information about a non-use period and the prioritization information comprises a prioritization of the gentle charging mode for the non-use period. The non-use period can be in particular the time duration between two uses or until a next use of the battery unit B₁, Bₙ, in particular for supplying energy to a work apparatus. The non-use period can be determined e.g. by the respective user terminal 4₁, . . . , 4ₘ and/or the charging management base 3, in particular by evaluation of the use history information. The non-use period can be assigned individually to a respective battery unit B₁, Bₙ, in particular using the associated identifier information I₁, . . . , Iₙ; in particular, it need not be identical for all the battery units B₁, Bₙ. Additionally or alternatively, a non-use period can also be assigned to a respective identical charging group G₁, . . . , G_{q} or to all battery units B₁, . . . , B₁₁ assigned to the relevant identical charging group G₁, . . . , G_{q}. The non-use period can be e.g. a period at night and/or at the weekend.

In corresponding embodiments, the use history information comprises information about an expected use start time and the prioritization information comprises a prioritization of the rapid charging mode depending on the expected use start time. In this case, the expected use start time can be determined automatically by the system in particular without active assistance or action on the part of a user. Priority is granted to the rapid charging mode in particular if rapid charging of the relevant battery unit is required in order to have enough energy available in the battery unit at the expected beginning of the use.

In corresponding realizations, the user predefinition information comprises information about a use start time required in particular by the user and/or by means of the respective user terminal 4₁, . . . , 4ₘ, and the user terminals 4₁, . . . , 4ₘ and/or the charging management base 3 and/or the charging control unit 2 is/are configured to define the charging mode information and/or the charging parameter desired value information depending on the required use start time. In this way, by virtue of the user notifying the system of the desired use start time, the user can influence the definition of the charging mode information or the charging parameter desired value information in such a manner that the system can gear the charging process for a relevant battery unit optimally thereto. In this regard, e.g. a prioritization of the required use start time can be provided to the effect that the battery unit is charged in the rapid charging mode until it has reached a state of charge or charging level, i.e. charging capacity or energy content, needed at the required use start time, and is subsequently charged in a different charging mode, such as the non-charging mode or the gentle charging mode or the sustainable charging mode. For this purpose, the predefinition of the required use start time can be accompanied by a predefinition of a required state of charge of the battery unit B₁, . . . , Bₙ which the latter must or ought to have as a minimum at the use start time.

In advantageous embodiments, the respective charging control unit 2 is configured for detecting at least one charging-relevant battery state parameter of its battery unit B₁, . . . , Bₙ and for defining the charging parameter desired value information for the relevant battery unit B₁, . . . , Bₙ depending on the detected values of the at least one battery state parameter.

Such battery state parameters or battery state information can be in particular one or more of the following battery state variables: a state of charge, a state of health, the battery temperature, an, in particular maximum, end-of-charge voltage and an, in particular minimum, end-of-discharge voltage. The battery state information can be stored in or on or by the charging control unit 2. Furthermore, the charging control unit 2 can communicate this information via the communication connection 5 to the user terminals 4₁, . . . , 4ₘ and/or the charging management base 3, in particular in order to store and/or evaluate it there.

The battery state information can be taken into account by the charging control unit 2 and/or the user terminals 4₁, . . . , 4ₘ and/or the charging management base 3 in the definition of the charging mode information and/or the charging parameter desired value information, in particular optionally with the prioritization information additionally being taken into account. By way of example, it may be that a use start time is required by the user, but the charging control unit 2 nevertheless defines the charging parameter desired value information on the basis of the charging mode information without consideration of the required use start time and possibly also without consideration of other detected and/or stored battery state information in such a way as to avoid an otherwise impending overloading and/or overheating and/or damage of the battery unit B₁, . . . , Bₙ during or as a result of the charging process.

Taking account of the battery state information for being in command of a respective battery charging process can mean, in particular, that for various battery units B₁, . . . , Bₙ having different battery states, different items of charging mode information or charging parameter desired value information are defined, even if an identical charging mode would be appropriate for them initially, i.e. without taking account of their battery state. That may be the case e.g. if two battery units B₁, . . . , Bₙ have different states of health.

In a preferred embodiment, in the definition of the charging mode information or the charging parameter desired value information, the battery state information is always given higher prioritization than use history information and/or charging modes predefined by the user and/or other predefinitions, such as a use start time.

The respective charging control unit 2 can e.g. store limit values for the detected battery state variables and define the charging parameter desired value information depending on a comparison of the detected battery state information with the associated battery state limit values.

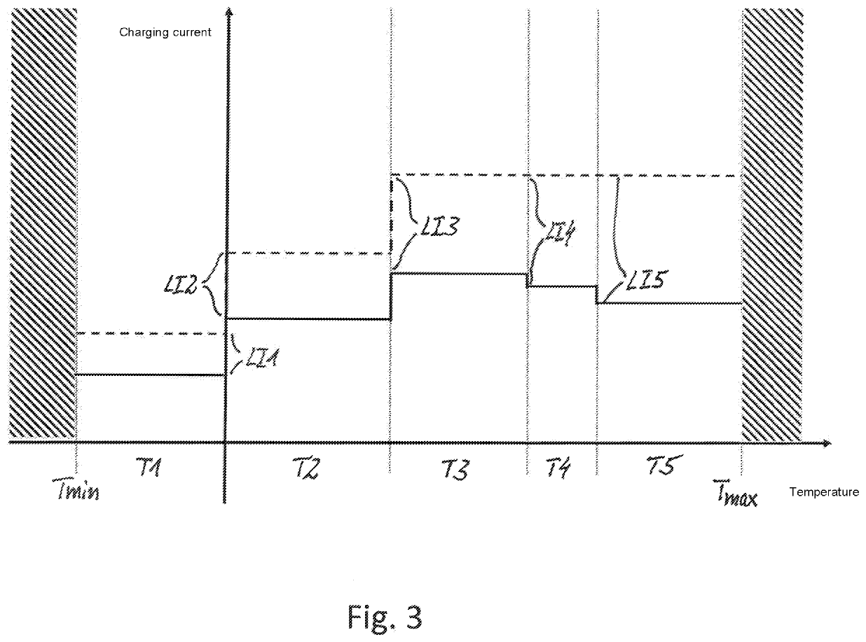

In advantageous embodiments, the charging parameter desired value information comprises different charging current and/or charging voltage desired value predefinitions for at least five different battery temperature ranges, as illustrated for an example with seven different battery temperature ranges in the characteristic curve diagram in FIG. 3. In FIG. 3, by way of example, a first charging mode is illustrated by a characteristic curve profile of the charging current as a function of the battery temperature, this profile being represented by solid lines, and a second charging mode is illustrated by a characteristic curve profile represented by dashed lines. In both charging modes, the charging parameter desired value information predefines the non-charging mode below a minimum temperature Tmin and above a maximum temperature Tmax. For a sequence of at least two battery temperature ranges, three battery temperature ranges T1, T2, T3 in the example shown, that are adjacent to the minimum temperature Tmin, the charging parameter desired value information predefines a progressively higher charging current LI1, LI2, LI3 and in general also a progressively higher charging voltage. For a sequence of at least two battery temperature ranges adjacent to the maximum temperature Tmax, once again a sequence of three battery temperature ranges T3, T4, T5 in the example shown, the charging parameter desired value information predefines a charging current LI4, LI5 that is constant in the second charging mode and progressively lower in the first charging mode, and in general also a constant or progressively lower charging voltage. In concrete terms, in the example shown, the charging current reduction in each of the two stages before the maximum temperature Tmax is smaller in terms of absolute value than the charging current increase in each of the two stages after the minimum temperature Tmin.

Generally, e.g. three to twenty-two, preferably between five and ten, temperature ranges can be defined. The charging parameter desired value information can additionally be dependent on further battery state information. By way of example, a dependence on the state of health of the battery unit B₁, . . . , Bₙ is possible in this regard. It is likewise possible for the charging parameter desired value information to be defined by the charging control unit 2 in such a way that specific temperature ranges are avoided, that is to say that no charging of the battery unit B₁, . . . , Bₙ takes place in that case. Furthermore, it is possible for specific charging parameter desired value information to be permitted or defined by the charging control unit 2 only in specific temperature ranges, and not in specific other temperature ranges. Furthermore, provision can be made for specific charging parameter desired value information to be defined in a constant fashion independently of temperature information or across all temperature ranges.

The number of temperature ranges and the division thereof can be defined depending on the battery state information, in particular the state of health of the battery unit B₁, . . . , Bₙ. Furthermore, it is possible for the temperature ranges for the battery units B₁, . . . , Bₙ to be identical or different. Provision can also be made for the temperature ranges for all battery units B₁, . . . , Bₙ which are assigned to a specific identical charging group, e.g. the identical charging group G₁, to be identical and the temperature ranges for all battery units B₁, . . . , Bₙ, which are assigned to a different identical charging group, e.g. the identical charging group G₂, likewise to be identical, but different from those of the battery units B₁, . . . , Bₙ associated with the first identical charging group G₁.

The battery charging management system illustrated in FIGS. 1 and 2 makes it possible to perform a battery charging management method for the battery fleet 1 having the battery units B₁, . . . , Bₙ, wherein the charging setting information for the battery units B₁, Bₙ is transferred by the charging management base 3, the battery units B₁, . . . , Bₙ are equipped with the respective charging control unit 2, the user terminals 4₁, . . . , 4ₘ are provided, and transfer battery-charging-related user predefinition information, provision is made of the communication connection 5 for data transfer between the charging management base 3 at one end and the battery units B₁, . . . , Bₙ at the other end and between the user terminals 4₁, . . . , 4ₘ at one end and the charging management base 3 and/or the battery units B₁, . . . , Bₙ at the other end, the charging setting information and/or the user predefinition information comprise(s) the charging mode information with regard to the different charging modes, the charging setting information from the charging management base 3 and/or the user predefinition information from the user terminals 4₁, . . . , 4ₘ are/is fed to the charging control unit in the respective battery unit B₁, . . . , Bₙ via the communication connection 5, and for the purpose of performing a charging process for the respective battery unit B₁, . . . , Bₙ coupled to the charger 8, by way of the charging control unit 2 of said battery unit, the associated charging parameter desired value information is defined depending on the charging setting information and/or user predefinition information fed and is communicated to the charger.

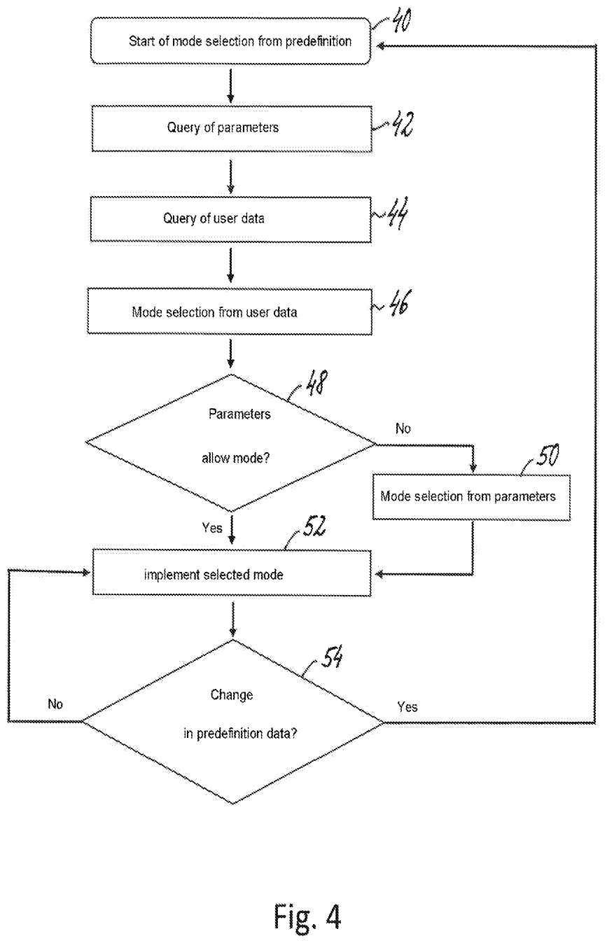

FIG. 4 shows a flow diagram illustrating a specific part of the battery management method in one exemplary embodiment. As evident therefrom, in a step 40, a set of items of charging mode information is available to the charging control unit 2. This charging mode information can be derived in particular from the preceding charging setting information and/or user predefinition information and optionally battery state information present previously. In a step 42, the respective charging control unit 2 queries the battery state parameters presently available, such as e.g. the temperature of the battery unit B₁, Bₙ. In a step 44, the charging control unit 2 queries the user predefinition information, such as e.g. a required use start time. Depending on the user predefinition information and the charging setting information, the charging control unit 2 defines a present charging mode in a step 46.

Subsequently, in a query step 48, the charging mode determined from the user data in step 46 is linked or compared with the battery state parameters queried in step 42. The linking or the comparison of these data takes account of the prioritization of the charging mode information present and results in corresponding prioritization information. This prioritization information comprises the information as to whether or not the battery state parameters permit the selected charging mode. If this is not the case, in a step 50, the charging mode is determined or defined anew on the basis of the battery state parameters and the preselected charging mode. Otherwise, the charging mode preselected by the user or previously prioritized by the system is maintained by the charging control unit 2, that is to say that the battery state parameters do not change the predetermined charging mode in this case. Subsequently, in a step 52, the charging process is then implemented with the present charging mode that has been ascertained in such a way.

In a step 54, a check is made to establish whether new or changed charging setting information and/or user predefinition information, in particular charging mode information, and/or battery state information, are/is present. If this is not the case, the previously implemented charging mode is maintained. By contrast, if changed or new information is present, the method returns to step 40 and updating of the charging mode or of the charging parameter desired value information is performed on the basis of this new or changed information.

As made clear by the above description of exemplary embodiments by way of example, the invention provides a battery charging management system and a battery charging management method which enables the battery units of a battery fleet to be managed in a very advantageous manner in regard to their states of charge, their charging procedures and their assignment to use teams.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery charging management system for a battery fleet having a plurality of rechargeable, communication-enabled, battery units, comprising:
a charging management base configured for transmitting charging setting information for the battery units;
a plurality of user terminals configured for transmitting battery-charging-related user predefinition information;
a respective charging control unit in each of the battery units; and
a communication connection for data transfer between the charging management base at one end and the battery units at the other end, and between the user terminals at one end and the charging management base and/or the battery units at the other end,
wherein the charging setting information and/or the user predefinition information comprise(s) charging mode information with regard to a plurality of different charging modes for the battery units,
wherein the charging setting information from the charging management base and/or the user predefinition information from the user terminals are/is able to be fed to the charging control unit in the respective battery unit via the communication connection, and
wherein the charging control unit is configured, for a purpose of performing a charging process of its battery unit coupled to a charger, to define associated charging parameter desired value information depending on the fed charging setting information and/or user predefinition information, and to communicate the defined associated charging parameter desired value information to the charger.

2. The battery charging management system according to claim 1, wherein
the battery units are embodied as rechargeable battery packs for supplying energy to hand-guided work apparatuses.

3. The battery charging management system according to claim 2, wherein
the hand-guided work apparatuses are hand-guided garden, forestry, construction and/or groundwork apparatuses.

4. The battery charging management system according to claim 1, wherein
identifier information is allocatable to each battery unit, and
the user terminals and/or the charging management base are/is configured for grouping the battery units into one or more identical charging groups using the identifier information.

5. The battery charging management system according to claim 1, wherein
the charging modes comprise a plurality out of:
a non-charging mode, a normal charging mode, a rapid charging mode, a gentle charging mode, and a sustainable charging mode, and
the charging management base and/or the user terminals and/or the charging control units is/are configured to define the charging mode information and/or the charging parameter desired value information depending on prioritization information and/or use history information.

6. The battery charging management system according to claim 5, wherein
the use history information comprises information about a non-use period, and
the prioritization information comprises a prioritization of the gentle charging mode for the non-use period.

7. The battery charging management system according to claim 5, wherein
the use history information comprises information about an expected use start time, and
the prioritization information comprises a prioritization of the rapid charging mode depending on the expected use start time.

8. The battery charging management system according to claim 5, wherein
the user predefinition information comprises information about a required use start time, and
the user terminals and/or the charging management base and/or the charging control units is/are configured to define the charging mode information and/or the charging parameter desired value information depending on the required use start time.

9. The battery charging management system according to claim 1, wherein
the respective charging control unit is configured for detecting at least one charging-relevant battery state parameter of its battery unit and for defining the charging parameter desired value information for the relevant battery unit depending on the detected values of the at least one battery state parameter.

10. The battery charging management system according to claim 1, wherein
the charging parameter desired value information comprises different charging current and/or charging voltage desired value predefinitions for at least five different battery temperature ranges,
the charging parameter desired value information predefines a non-charging mode below a minimum temperature and above a maximum temperature, predefines a progressively higher charging current and/or a progressively higher charging voltage for a sequence of at least two battery temperature ranges adjacent to the minimum temperature, and predefines a constant or progressively lower charging current and/or a constant or progressively lower charging voltage for a sequence of at least two battery temperature ranges adjacent to the maximum temperature.

11. The battery charging management system according to claim 1, wherein
the charging setting information and/or the user predefinition information include(s) at least one out of:
target battery capacity information, target battery energy information, target battery voltage information, and target battery use duration information.

12. A battery charging management method for a battery fleet having a plurality of rechargeable, communication-enabled, battery units, each of which is equipped with a charging control unit, the method comprising:
transferring, by a charging management base, charging setting information for the battery units,
transferring, by a plurality of user terminals, battery-charging-related user predefinition information;
wherein the charging setting information and/or the user predefinition information comprise(s) charging mode information with regard to a plurality of different charging modes for the battery units;
feeding the charging setting information from the charging management base and/or the user predefinition information from the user terminals to the charging control unit in the respective battery unit via a communication connection, and
for performing a charging process for the respective battery unit coupled to a charger, by way of the charging control unit of said battery unit, defining associated charging parameter desired value information depending on the fed charging setting information and/or user predefinition information, and communicating the defined associated charging parameter desired value information to the charger.

13. The battery charging management method according to claim 12, wherein the method is carried out by the battery charging management system according to claim 1.

14. The battery charging management method according to claim 12, wherein for performing a respective charging process of one of the battery units by way of the associated charging control unit, the charging parameter desired value information is defined and periodically updated depending on detected actual values of the at least one charging-relevant battery state parameter of the battery unit.
